(19) United States
(12) Patent Application Publication
(10) Pub. No.: US 2007/0091176 A1
(43) Pub. Date: Apr. 26, 2007

(54) Method for executing data compression with surveillance hosts

(75) Inventors: Victor Shih, Taipei (TW); Cheng-Jyh Chang, Taipei (TW); Ice Chien, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Avermedia Technologies, Inc.

(21) Appl. No.: 11/401,661

(22) Filed: Apr. 11, 2006

(30) Foreign Application Priority Data
Oct. 24, 2005 (TW) 094137175

(51) Int. Cl. H04N 9/47; H04N 7/18

(52) U.S. Cl. 348/143

(57) ABSTRACT

A method for executing data compression is used with a first surveillance host and a second surveillance host communicated with each other via a network. The second surveillance includes a memory device. At first, the first surveillance host compresses video signals into first compressed video data according to a first compression method and uploads the first compressed video data to the network. Next, the second surveillance host downloads the first compressed video data generated by the first surveillance host via the network. Then, the second surveillance host compresses the first compressed video data into second compressed video data according to a second compression method and stores the second compressed video data in the memory device. The second compressed video data has a higher compression ratio than the first compressed video data.

### FIELD OF THE INVENTION

The present invention relates to a method for executing data compression with surveillance hosts, and more particularly to a method for executing data compression between a first surveillance host and a second surveillance host.

### BACKGROUND OF THE INVENTION

In the modern community, surveillance system is used widely in shops, apartments, companies, warehouses, and houses. It becomes essential on some occasions. Since the offices and factories belonging to the same company are usually located on different sites, a digital video recorder (DVR) surveillance system is developed to meet such situation. Taking advantage of the networking and digitized properties of the DVR, the user can perform a real-time remote surveillance for different offices and factories to prevent suffering loss by theft or observe how the employees behave.

Please refer to FIG. 1 which is a functional block diagram of a conventional DVR surveillance system. The DVR surveillance system comprises cameras 101, 102 . . . 10n, a surveillance host 11, and a monitor 12. The pictures captured by the cameras 101, 102 . . . 10n are transmitted to the surveillance host 11 for processing, and then video data are generated and transmitted to the monitor 12 for displaying. Hence, the real-time videos associated with the cameras 101, 102 . . . 10n located in different sites can be shown on the monitor 12. The video data are also transmitted from the surveillance host 11 to a remote computer system 14 via the network 13 to show the real-time videos on the computer monitor 15. In this way, the user can monitor objects through the cameras 101, 102 . . . 10n, even located on different sites, with the connection between the remote computer system 14 and the network 13.

The video signals generated by the cameras 101, 102 . . . 10n and processed by the surveillance host 11 are usually compressed into video data presented in moving picture experts group level 4 (MPEG-4) format for storing or transferring. The size of the video data in MPEG-4 format is significantly reduced as compared with the original video signals so that the recording period can be extended in an advantageous manner. Furthermore, the operating of MPEG-4 compression/decompression is fast enough to achieve almost real-time monitoring. Hence, the MPEG-4 compression and decompression functions are usually integrated into a standard interface card applied to different electronic apparatus. The operating speed can reach to 1.5 MB to 3 MB per second, which is fast enough for a personal computer to show a full screen movie having a frame rate of 30 frame/sec.

MPEG-4 format, however, is not the format with the best compression ratio. H.264 format, a digital video codec standard for advanced video coding, is noted for achieving very high compression ratio, about 30% to 40% greater than MPEG-4 format. It means that the videos with perfect quality can be presented by a small amount of video data in H.264 format. The files for storing these video data are thus reduced in size. As comparing with the video data in MPEG-4 format, video data in H.264 format can save more storage space of the surveillance host 11 and get a longer recording period for DVR surveillance system. Accordingly, it is a growing trend in compressing video data into H.264 video data. However, compressing video data into H.264 video data will consume most of resources of the surveillance host 11, while the surveillance host 11 has to simultaneously process the video signals received from many cameras located on different sites to generate the video data. Hence, the surveillance host 11 cannot timely handle the H.264 compression, which slows down the compression speed. The video data uploads into the network 13 and downloaded by the remote computer system 14 aren't real-time video data anymore. It is an objective to ameliorate the prior art.

### SUMMARY OF THE INVENTION

Therefore, the present invention provides a method for executing data compression with surveillance hosts, which is applicable to DVR surveillance system in a more efficient manner.

A method for executing data compression with a first surveillance host and a second surveillance host communicated with each other via a network is provided, wherein the second surveillance includes a memory device. At first, the first surveillance host compresses video signals into first compressed video data according to a first compression method and uploads the first compressed video data to the network. Next, the second surveillance host downloads the first compressed video data generated by the first surveillance host via the network. Then, the second surveillance host compresses the first compressed video data into second compressed video data according to a second compression method and stores the second compressed video data in the memory device. The second compressed video data has a higher compression ratio than the first compressed video data.

In an embodiment, the first surveillance host is connected to at least one camera for receiving the video signals generated by the camera(s) and compressing the video signals into the first compressed video data according to the first compression method.

In an embodiment, the second surveillance host downloads the first compressed video data associated with a specific one of the cameras and decompresses the first compressed video data to show video on a display.

In an embodiment, the first compression method is executed to compress uncompressed video data into he first compressed video data with a first compression ratio. The second compression method is executed to compress the first compressed video data into the second compressed video data with a second compression ratio, which is higher than the first compression ratio.

In an embodiment, the first compressed video data are presented in MPEG-4 format, MPEG-2 format or AVI format. The second compressed video data are presented in H.264 format.

In an embodiment, the first surveillance host is a DVR surveillance computer system and the second surveillance host is a remote computer system capable of remotely controlling the DVR surveillance computer system.

In another embodiment, the first surveillance host is a video conference computer system and the second surveillance host is a remote computer system capable of remotely controlling the video conference computer system.

In an embodiment, the memory device is a hard disk of the second surveillance host for storing the second compressed video data.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a functional block diagram illustrating a conventional DVR surveillance system;

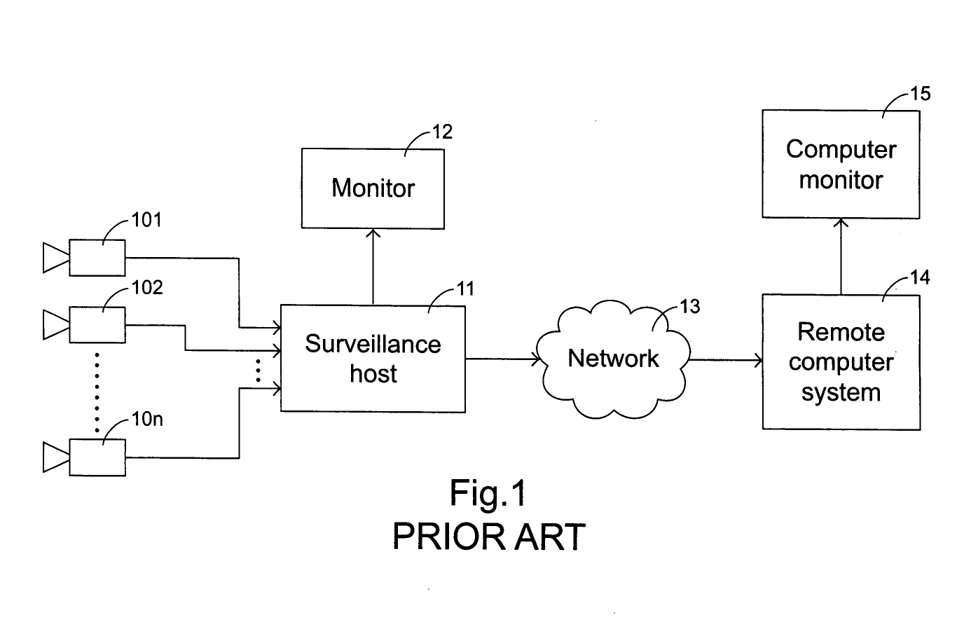

FIG. 2 is a functional block diagram illustrating the means of executing data compression with surveillance hosts according to the present invention;

FIG. 3 is a functional block diagram exemplifying a preferred embodiment of FIG. 2;

FIG. 4 is a functional block diagram exemplifying another preferred embodiment of FIG. 2; and

FIG. 5 is a flow chart illustrating the method for executing data compression with surveillance hosts.

### DETAILED DESCRIPTION OF PREFERRED EMBODIMENTS

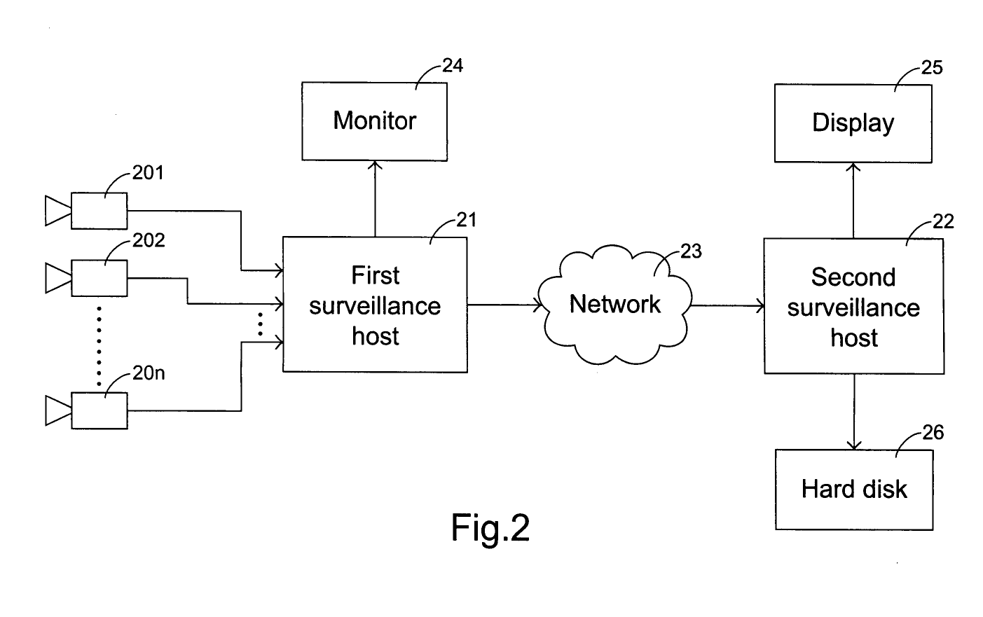

Please refer to FIG. 2 which is a functional block diagram illustrating the means of executing data compression with surveillance hosts. The method of the present invention is used with a network 23, a first surveillance host 21 and a second surveillance host 22. The first surveillance host 21 is connected to a plurality of cameras 201, 202 . . . 20n. The video signals, generated by the cameras 201, 202 . . . 20n located in different places, are transmitted to the monitor 24 via the first surveillance host 21 for real-time displaying. Meanwhile, the first surveillance host 21 compresses the video signals into first compressed video data presented in a first compression format according to a first compression method, which can compress uncompressed video data into the first compressed video data having a first compression ratio, e.g. 30%. The first compression format may be one of MPEG-4 format, MPEG-2 format, AVI format, etc. Then, the first compressed video data are uploaded to the network 23. Next, the second surveillance host 22 will download a desired portion of the first compressed video data via the network 23, and decompress the downloaded compressed video data. The decompressed video data are transmitted to the monitor 25 to achieve remote surveillance. Furthermore, the second surveillance host 22 not only downloads and displays the first compressed data but also compresses the first compressed video data into a second compressed video data presented in a second compression format according to a second compression method, which can compress the first compressed video data into the second compressed video data having a second compression ratio, e.g. 50%. The second compression format may be H.264 format. By this way, the video signals generated by the cameras 201, 202 . . . 20n can be compressed into the second compressed video data presented in the second compression format by the second surveillance host 22 so as to reduce their size. Hence, the hard disk drive 26, involved in or disposed outside the second surveillance host 22 can store more and more compressed video data and extend the recording period for effective surveillance.

According to the concept of the present invention, the second surveillance host 22 downloads the first compressed video data uploaded by the first surveillance host 21 via the network 23, and then further compresses the first compressed video data into the second compressed video data with a higher compression ratio. Since it is unnecessary for the second surveillance host 22 to process video signals received from cameras as the first surveillance host 21, the second surveillance host 22 has more resources than the first surveillance host 21 to compress the first compressed video data into the second compressed video data with a higher compression ratio while achieving the real-time displaying. Hence, the defects in the prior art as aforementioned are well solved. Taking the available resources into consideration, the first surveillance host 21 is used for compressing the video signals into video data presented in MPEG-4, MPEG-2 or AVI formats. The video data presented in MPEG-4, MPEG-2 or AVI formats are further compressed by the second surveillance host 22 to obtain video data presented in H.264 format with higher compression ratio while keeping the display quality. Thus, the hard disk 26 can store more video data and the recording period is also extended so as to improve the conventional surveillance equipment.

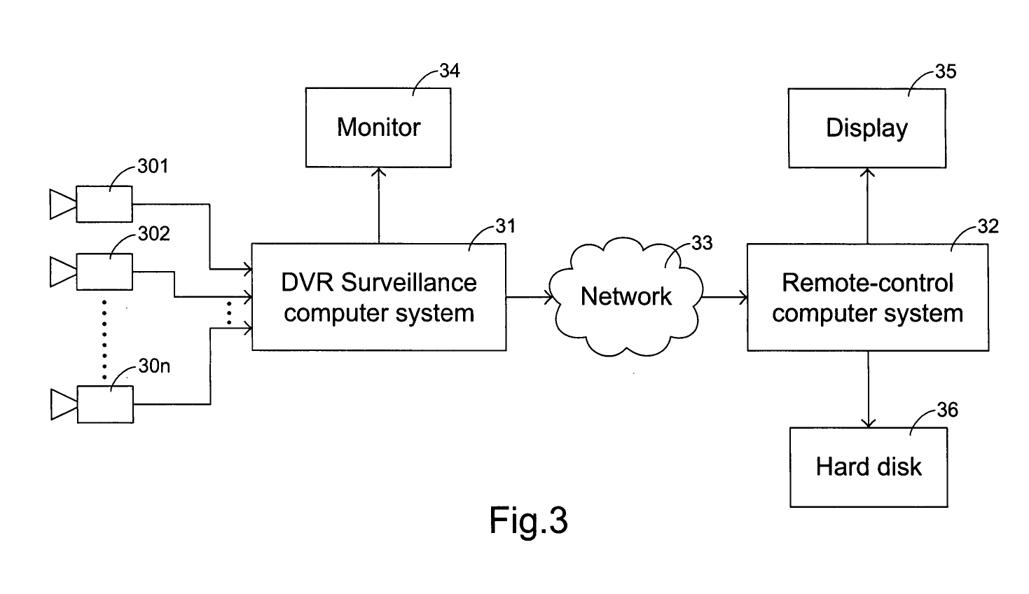

Please refer to FIG. 3 which is a functional block diagram illustrating a first preferred embodiment of executing data compression according to the present invention. It this embodiment, the first and second surveillance hosts are a digital video recorder (DVR) surveillance computer system 31 and a remote-control computer system 32, respectively. The DVR surveillance computer system 31 is connected to a plurality of cameras 301, 302 . . . 30n. The video signals generated by the cameras 301, 302 . . . 30n are transmitted to the DVR surveillance computer system 31 and shown on the monitor 34. The user can perform a real-time surveillance for the conditions of different places through divided frames shown on the monitor 34. Meanwhile, the DVR surveillance computer system 31 compresses the video signals into compressed video data presented in MPEG-4, MPEG-2 or AVI format and then uploads the compressed video data to the network 33. As described in the foregoing paragraph, the remote-control computer system 32 downloads the compressed video data in MPEG-4, MPEG-2 or AVI format via the network 33, and then further compresses them into compressed video data presented in H.264 format with a higher compression ratio. Thus, the hard disk 36 connected to the remote-control computer system 32 can store more video data and the recording period is also extended. The remote-control computer system 32 can optionally downloads a desired portion of the compressed video data generated by the DVR surveillance computer system 31 from the network 33, and correspondingly performing a real-time displaying on the display 35.

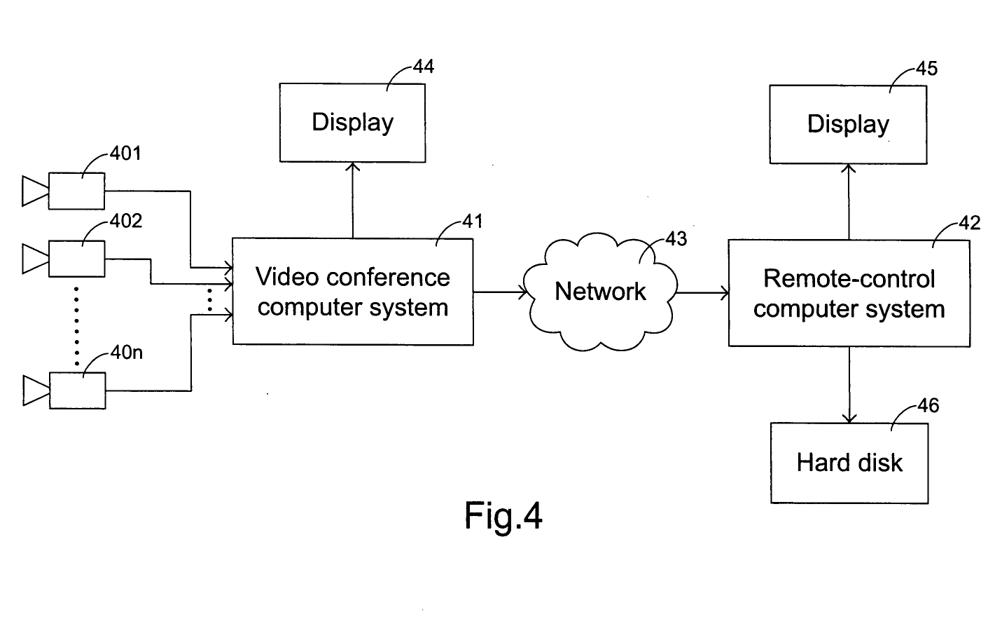

Please refer to FIG. 4 which is a functional block diagram illustrating a second preferred embodiment of executing data compression according to the present invention. It this embodiment, the first and second surveillance hosts are a video conference computer system 41 and a remote-control computer system 42, respectively. The video conference computer system 41 is connected to a plurality of web cameras 401, 402 . . . 40n. The video signals generated by the web cameras 401, 402 . . . 40n are transmitted to the video conference computer system 41 and shown on the display 44. The user can have a video conference with other conference members located at different places through divided frames shown on the display 44. Meanwhile, the video conference computer system 41 compresses the video signals into compressed video data presented in MPEG-4, MPEG-2 or AVI format and then uploads the compressed video data to the network 43. As described above, the remote-control computer system 42 downloads the compressed video data in MPEG-4, MPEG-2 or AVI format uploaded by the video conference computer system 41 via the network 43, and then further compresses them into compressed video data presented in H.264 format with a higher compression ratio. Thus, the hard disk 46 connected to the remote-control computer system 42 can store more video data and the recording period is extended. The remote-control computer system 42 can optionally downloads a desired portion of the compressed video data generated by video conference computer system 41 from the network 43, and correspondingly performing a real-time displaying on the display 45.

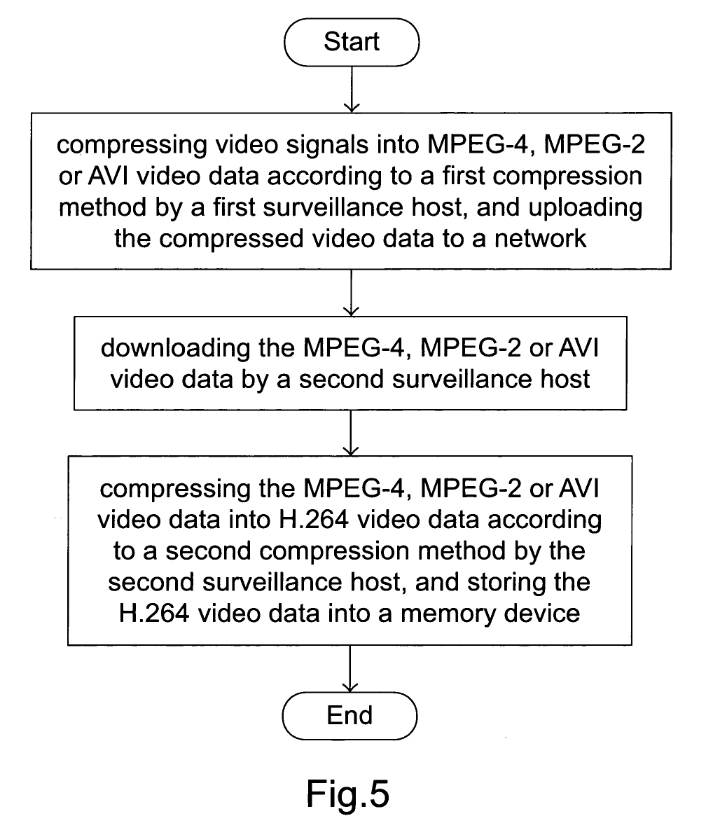

Please refer to FIG. 5 which is a flow chart of the method for executing data compression with surveillance hosts according to the present invention. The method is used with a network, a first surveillance host and a second surveillance host. At first, the first surveillance host compresses video signals into compressed video data presented in MPEG-4, MPEG-2 or AVI format according to a first compression method, and uploads the compressed video data to the network. Next, the second surveillance host downloads the compressed video data in MPEG-4, MPEG-2 or AVI format generated by the first surveillance host via the network. Then, the second surveillance host compresses the received compressed video data in MPEG-4, MPEG-2 or AVI format into another compressed video data presented in H.264 format according to a second compression method, and stores the last compressed video data into a memory device.

According to the above-mentioned embodiments, the present invention utilizes remote-control computer system for obtaining compressed video data with a higher compression ratio. Since the loading of the remote-control computer system is not as heavy as the loading of the DVR surveillance computer system or the video conference computer system as exemplified in the embodiments, the remote-control computer system will have enough resources to efficiently execute data compression. Under the condition of keeping high quality of the real-time displaying, still more compressed video data can be stored in the memory device, which significantly improves the conventional surveillance system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for executing data compression with a first surveillance host and a second surveillance host communicated with each other via a network, said second surveillance host comprising a memory device, said method comprising steps of:
compressing video signals into first compressed video data according to a first compression method by the first surveillance host and uploading said first compressed video data to the network;
downloading said first compressed video data generated by the first surveillance host via the network; and
compressing said first compressed video data into second compressed video data according to a second compression method by the second surveillance host and storing said second compressed video data in the memory device,
wherein said second compressed video data has a higher compression ratio than said first compressed video data.

2. The method according to claim 1 wherein the first surveillance host is connected to at least one camera for receiving said video signals generated by said at least one camera and compressing said video signals into said first compressed video data according to said first compression method.

3. The method according to claim 2 wherein the second surveillance host downloads said first compressed video data associated with a specific one of said at least one camera and decompresses said first compressed video data to show video on a display.

4. The method according to claim 1 wherein said first compression method is executed to compress uncompressed video data into said first compressed video data with a first compression ratio, and said second compression method is executed to compress said first compressed video data into said second compressed video data with a second compression ratio, which is higher than said first compression ratio.

5. The method according to claim 4 wherein said first compressed video data are presented in one selected from a group consisting of MPEG-4 format, MPEG-2 format and AVI format, and said second compressed video data are presented in H.264 format.

6. The method according to claim 1 wherein the first surveillance host is a digital video recorder (DVR) surveillance computer system and the second surveillance host is a remote computer system capable of remotely controlling said DVR surveillance computer system.

7. The method according to claim 1 wherein the first surveillance host is a video conference computer system and the second surveillance host is a remote computer system capable of remotely controlling said video conference computer system.

8. The method according to claim 1 wherein the memory device is a hard disk of the second surveillance host for storing said second compressed video data.
